(19) United States
(12) Patent Application Publication
(10) Pub. No.: US 2026/0008207 A1
(43) Pub. Date: Jan. 8, 2026

(54) METHOD AND APPARATUS FOR PROCESS MONITORING DURING PRODUCTION OF A FINISHED PART FROM A HOT-CROSSLINKING MATERIAL IN A PRIMARY SHAPING PROCESS

(71) Applicant: Baden-Württemberg Stiftung gGmbH, Stuttgart (DE)

(72) Inventors: Dennis Mayer, Esslingen (DE); Dennis Weisser, Esslingen (DE); Matthias Deckert, Esslingen (DE)

(73) Assignee: Baden-Württemberg Stiftung gGmbH, Stuttgart (DE)

(21) Appl. No.: 18/878,418

(22) PCT Filed: Jun. 27, 2023
(86) PCT No.: PCT/EP2023/067425

§ 371 Date: Dec. 23, 2024

(30) Foreign Application Priority Data
Jun. 30, 2022 (DE) 10 2022 206 727.4

(51) Int. Cl. B29C 35/02; B29C 45/76; B29C 45/77; B29K 83/00

(52) U.S. Cl. CPC B29C 35/0288; B29C 45/7613; B29C 45/77; B29C 2945/7601; B29C 2945/76137; B29C 2945/76558; B29C 2945/76561; B29C 2945/76963; B29K 2083/005

(57) ABSTRACT

The invention relates to a method for process monitoring during production of a finished part (112) in a primary shaping process. The method comprises the following steps: a) providing at least one mould (114) designed for the primary shaping process, wherein the mould (114) has at least one cavity (116) for receiving at least one starting material for the hot-crosslinking material, and wherein an apparatus for determining a mould internal pressure is also integrated into the mould (114); b) heating the mould (114); c) introducing the at least one starting material for the hot-crosslinking material into the cavity (116) under pressure such that the finished part (112) is produced; d) detecting a progression of the mould internal pressure occurring in step c); e) differentiating, at least once or at least twice, the progression of the mould internal pressure in order to determine at least one derivative selected from the group consisting of: the first-order derivative and the second-order derivative; and f) characterising a progression of a chemical crosslinking reaction by means of at least one derivative selected from the group consisting of: the first-order derivative and the second-order derivative.

The present invention relates to a method and an apparatus for process monitoring during production of a finished part from a hot-crosslinking material in a primary forming process. The method and the apparatus make it possible to continuously monitor the quality of the finished part in a series production. The present invention can be relevant in particular for the production of component parts with large numbers of items in the aircraft and vehicle industry and in medical technology. Other fields of application in the aircraft and vehicle industry, medical technology, the electronics industry, the consumer goods industry, the cosmetics industry and in the sanitary articles industry are also fundamentally conceivable.

### PRIOR ART

In general, process monitoring during a primary forming process is of great importance, in particular in the context of quality assurance and control for safety-relevant component parts in the automotive and aviation industry or in medical technology. Accordingly, there are many approaches here concerned with the topic of process monitoring.

One reliable option for investigating the crosslinking reaction, as an important process variable and quality feature, is fundamentally carrying out a differential thermal analysis for measuring quantities of heat given off or taken up by a specimen on being heated, cooled or during an isothermal process. Fundamentally, an encapsulated vessel containing a specimen in a quantity for example in the range of 5 mg to 40 mg, and a second encapsulated reference vessel without contents are subjected together to the same temperature change program in a testing chamber. Owing to the thermal properties of the specimen and exothermic or endothermic processes and/or phase changes, such as melting or evaporating, in principle temperature differences between the specimen and the reference arise, since during the process under investigation, fundamentally thermal energy flows into or out of the specimen. For the differential thermal analysis, the heat flow is used as measured variable. A further option for process monitoring of crosslinking substances during a primary forming process is, in principle, indirect measurements taken using a rotary rheometer. A further option for process monitoring of crosslinking substances during a primary forming process consists, in principle, in the use of a dielectric analysis (DEA).

The two methods described, however, fundamentally require special measuring instruments and corresponding software. The methods can fundamentally not be integrated in the manufacturing process. The methods can fundamentally not be used to establish a degree of crosslinking in the manufacturing process and thus also cannot supply traceable quality and process data.

The prior art also discloses various methods that make use of different measured variables and parameters, such as the temperature, flow behavior, electrical conductivity or pressure for process monitoring purposes.

DE 10 2015 107 024 B3 describes a method for ascertaining a number of process parameter values in an injection molding process within an injection mold. Geometric data relating to the injection mold and/or a molding that is to be produced in the injection mold are ascertained. The geometric data are used to ascertain a virtual, molding-specific pressure curve for an injection molding process, and this curve is taken as a basis to ascertain a molding-specific event pattern which includes a plurality of singular virtual events that are linked to characteristic locations of events on the geometry of the molding and are assigned in each case at least one item of relative time information and at least one position datum, which defines a position of a melt front of the injection molding material in the injection mold.

EP 0 897 786 A2 describes a method for controlling an injection molding installation. The injection unit injects melt into a cavity under supervision. The cavity internal pressure is measured and monitored. The examination, after each cycle, of one or more control parameters influencing the profile of this pressure is novel. These parameters include the injection velocity, the follow-up pressure level, the follow-up pressure range and the mold temperature. A control variable obtained in this way determines whether it is necessary to reset the relevant parameter. If it is, a suitable adjustment is made.

EP 0 854 778 B1 describes a measurement of the tool internal pressure during a cycle of a cyclically operating machine as a function of time and/or the delivery distance covered. Then, the tool internal pressure is differentiated as a function of the period of time and/or distance covered, and the evaluation results are checked for deviations on the monotonous curve. If there are deviations, the subsequent compression time and/or the switching time are modified until the profile of the tool internal pressure becomes a monotonous profile.

The publication by P. Rosenberg et al., “Investigating cavity pressure behavior in high-pressure RTM process variants”, 2015, AIP Conference Proceedings, is concerned with new variants of the high-pressure RTM process, specifically high-pressure injection RTM (HP-IR™) and high-pressure compression RTM (HP-CR™) for producing carbon-fiber-reinforced composite materials with a high fiber content by volume. Both processes make use of high-pressure RTM installations for precise metering and mixing of highly reactive epoxy resins and amine curing agents with relatively high throughputs.

The cited publications, however, fundamentally describe an analysis of the tool internal pressure during RTM and injection molding processes with thermoplastic and thermosetting plastics and not in relation to liquid silicone rubber.

### OBJECT OF THE INVENTION

The object of the present invention is therefore to at least partially overcome the disadvantages and restrictions known from the prior art. In particular, the intention is to propose a method and an apparatus for process monitoring during production of a finished part from a hot-crosslinking material in a primary forming process, which enables precise component-part and/or process monitoring.

### DISCLOSURE OF THE INVENTION

This object is achieved by a method and an apparatus for process monitoring during production of a finished part from a hot-crosslinking material having the features of the independent claims. Advantageous configurations are in the dependent claims.

Hereinafter the terms “have”, “comprise” or “include” or any grammatical variations of these are used in a non-exclusive way. Accordingly these terms can refer either to situations in which no further features are present apart from the features introduced by these terms or to situations in which one or more further features are present. For example, the expression “A has B”, “A comprises B” or “A includes B” can refer both to the situation in which no further element apart from B is provided in A (that is to say to a situation in which A consists exclusively of B) and to the situation in which, in addition to B, one or more further elements are provided in A, for example element C, elements C and D, or even further elements.

It is also pointed out that the terms “at least one” and “one or more” and grammatical variations of these terms, when they are used in connection with one or more elements or features and are intended to express that the element or feature may be provided once or multiple times, are generally only used once, for example when the feature or element is introduced for the first time. When the feature or element is subsequently mentioned again, the corresponding term “at least one” or “one or more” is generally no longer used, without restricting the possibility that the feature or element may be provided one or more times.

Furthermore, hereinafter the terms “preferably”, “in particular”, “for example” or similar terms are used in connection with optional features, without alternative embodiments being restricted thereby. Thus, features that are introduced by these terms are optional features, and it is not intended to restrict the scope of protection of the claims, and in particular of the independent claims, by these features. Thus, as a person skilled in the art will appreciate, the invention can also be carried out by using other configurations. In a similar way, features that are introduced by “in one embodiment of the invention” or by “in an exemplary embodiment of the invention” are understood to be optional features, without it being intended that alternative configurations or the scope of protection of the independent claims are restricted thereby. Furthermore, all of the possibilities of combining the features thereby introduced with other features, whether optional or non-optional features, are intended to remain unaffected by these introductory expressions.

In a first aspect, the present invention relates to a method for process monitoring during production of a finished part from a hot-crosslinking material in a primary forming process.

The term “primary forming process” is fundamentally to be understood as meaning any desired manufacturing process in which a solid body having a geometrically defined form is produced from a formless substance. The primary forming process may in be particular an injection molding process. In this case, polymers can be injected under pressure into a mold or cavity, which can also be referred to as injection molding tool. In the mold or cavity, the material can transition to a solid state by cooling or by virtue of a crosslinking reaction and, after the tool is opened, can be removed in the form of a finished part. The cavity of the tool may determine substantially a form and a surface structure of the finished part. In particular, the tool may have at least two molding plates that can be fitted together, in particular at least one nozzle-side mold plate and at least one closing-side mold plate. The nozzle-side mold plate can have an opening into which an injection device (nozzle) enabling the introduction of the starting substance of the hot-crosslinking material into the cavity has been introduced.

The term “process monitoring” fundamentally refers to any desired technical method for assessing a manufacturing process. The process monitoring makes it possible to reach a decision on whether it is necessary to intervene in the manufacturing process and/or whether it is necessary to modify the manufacturing process.

The term “finished part” in this respect is to be understood to mean a entity of three-dimensional extent that is to be investigated and is produced from a suitable material in the primary forming process, the finished part having a form defined by the form of a cavity in a tool which is set up for the primary forming process. The finished part may be for example specimens or workpieces for a laboratory, or products or prototypes, for instance parts of a motor vehicle, the production of which using the present method undergoes online monitoring. The finished part may also be referred to as molding.

The method comprises the following steps:
a) providing at least one tool which is set up for the primary forming process, the tool having at least one cavity for receiving at least one starting substance for the hot-crosslinking material, and further an apparatus for determining a tool internal pressure being integrated in the tool;
b) heating the tool;
c) introducing the at least one starting substance for the hot-crosslinking material under pressure into the cavity, such that the finished part is produced;
d) recording a tool internal pressure profile that develops in step c);
e) differentiating, at least once or at least twice, the tool internal pressure profile to determine at least one derivative selected from the following group: the first order derivative; the second order derivative; and
f) characterizing a profile of a chemical crosslinking reaction by means of at least one derivative selected from the following group: the first-order derivative; the second-order derivative.

The method can comprise the method steps described below. The method steps may be carried out in particular in the specified sequence. A different sequence is, however, also conceivable. Furthermore, one or more method steps may be carried out at the same time or overlapping in time. It is also possible for one or more, or all of the method steps to be carried out once or repeatedly. The method may in addition also comprise further method steps.

As stated above, the apparatus for determining the tool internal pressure is integrated in the tool. The term “integrated” denotes in this respect an arrangement of the apparatus which can be received fixedly or, preferably, detachably in the tool, in particular in the cavity of the tool. As a result, the apparatus is configured preferably such that it can withstand the temperature and pressure conditions that can arise in the cavity of the tool. In particular, the apparatus may be arranged in the cavity of the tool such that the apparatus is in contact with a wall of the cavity. The tool may in particular have an injection apparatus, such as a nozzle. The apparatus may be arranged in the vicinity of the injection apparatus. The apparatus may also be referred to as tool internal pressure sensor.

The apparatus for determining the tool internal pressure can be used in particular to directly determine and/or indirectly determine the tool internal pressure. The apparatus for determining the tool internal pressure can be set up to directly determine and/or indirectly determine the tool internal pressure.

Determining the tool internal pressure directly can have many advantages. In particular, determining the tool internal pressure directly can provide precise and reliable measured values. The pressure sensor may be placed directly in the tool and record an actual pressure inside the tool. In addition, placing pressure sensors at various locations in the tool makes it possible to measure the tool internal pressure at specific positions, in particular in order to identify local differences or problems.

The tool internal pressure can be determined indirectly for example by means of an ejector, for example by means of an ejector pin. Within the context of the present invention, an “ejector” is understood to be fundamentally an element which applies a force during a primary forming process in order to push a finished part out of a cavity of a tool. To indirectly determine the tool internal pressure, the ejector can comprise one or more force sensors. Furthermore, the tool internal pressure can be determined indirectly for example by a closing means, in particular by means of a needle valve, of the cavity. Furthermore, the tool internal pressure can be determined indirectly for example by means of measuring the closing force. Placing pressure sensors in closing units for the tool makes it possible to measure a force exerted on the tool and calculate back the tool internal pressure. Furthermore, the tool internal pressure can be determined indirectly for example by means of a hydraulic pressure measurement. The tool internal pressure fundamentally correlates with a hydraulic pressure of the injection molding machine. If a hydraulic pressure sensor is installed in a hydraulic system of the injection molding machine, the tool internal pressure can be ascertained indirectly by measuring the hydraulic pressure.

Determining the tool internal pressure indirectly can have many advantages. For example, indirectly determining the tool internal pressure makes it possible to avoid damage to sensors, for example when abrasive materials and/or high temperatures are used. By avoiding or reducing pressure sensors, costs can be reduced. In addition, it is possible to reduce a maintenance outlay and/or calibration outlay. Furthermore, avoiding or reducing pressure sensors makes it possible to reduce the space needed and reduce requirements for the precision on design and manufacture of the tool.

The apparatus for determining the tool internal pressure may be or comprise in particular a piezoelectric pressure sensor. The piezoelectric pressure sensor may have a crystal which generates an electrical charge proportional to the pressure applied. The apparatus for determining the tool internal pressure may in particular be selected from the following group: a piezoelectric pressure sensor using a direct and/or indirect measurement method; a piezoresistive pressure sensor using a direct and/or indirect measurement method. The brochure by Kistler Group “Test & Measurement Druck, Messausrüstung für anspruchsvolle T&M Anwendungen” [Pressure testing & measurement, measuring equipment for demanding T&M applications], 960-695d-06.20 @ 2018 . . . 2020 Kistler Group, describes in particular various piezoelectric pressure sensors.

The term “tool internal pressure” describes fundamentally a pressure generated in a tool, in particular in a tool with a cavity, during a primary forming process. As stated above, the primary forming process may be in particular an injection molding process and a tool internal pressure may be a pressure inside an injection molding tool. The tool internal pressure may be an indicator for the quality of a finished part. The tool internal pressure is fundamentally an impactful process variable which opens up to users in principle a comprehensive process transparency and can contribute to zero-fault production. The tool internal pressure fundamentally describes operations in the cavity of the tool. Therefore, the tool internal pressure can be used to draw conclusions about formation conditions during the primary forming process. Its profile during a filling, compression and/or follow-up pressure phase can in principle be assigned specific quality-relevant properties of the finished part, for example dimensional accuracy, surface area, weight or degree of shaping. The profile of the tool internal pressure is thus fundamentally a quality fingerprint which is specific to the part and can be used to make accurate statements regarding optimum process parameters throughout the primary forming process. The tool internal pressure profile may be in particular a variation over time of the tool internal pressure or a temperature-based tool internal pressure profile.

As stated above, the tool is heated in step b). The tool may have for example a temperature of 100° C. to 300° C., preferably 120° C. to 250° C. and particularly preferably 140° C. to 230° C. Other temperatures are also conceivable in principle. Fundamentally, the choice of temperature may depend on the nature of the material. The tool may have at least one heating apparatus, which may comprise for example one or more heating circuits. The heating apparatus may in particular be selected from the following group: an oil heater; a water heater; a frame heater, in particular an electric frame heater; a heating cartridge, in particular an electric heating cartridge; a heating wire. Other embodiments are also conceivable in principle. The heating apparatus may be arranged for example in at least one of the mold plates. Furthermore, the heating apparatus may be arranged in the vicinity of the cavity.

As stated above, in step c) the at least one starting substance for the hot-crosslinking material is introduced under pressure into the cavity, such that the finished part is produced. In particular, the at least one starting substance may be introduced into the cavity at a pressure of 5 bar to 700 bar, preferably 10 bar to 400 bar. Other pressures are also conceivable in principle. The introduction into the cavity may be effected in particular by a delivery unit, in particular by an extruder. In the processing of liquid silicone rubber, by contrast to thermoplastics processing, it is fundamentally also possible to work without a follow-up pressure, since in particular it is not necessary to compensate for any shrinkage. Although the starting substance is injected under pressure into the cavity, the pressure in the cavity rises fundamentally owing to unit volume expansion. In principle, only a needle valve nozzle is closed such that no material can escape from the cavity. Typical crosslinking times are, in principle, 20 s to 40 s. The crosslinking times in principle, however, greatly depend on the component-part thickness or finished-part thickness.

The term “hot-crosslinking material” refers in principle to any desired material in the case of which starting substances of the material crosslink with one another at high temperatures.

The high temperatures may be in particular temperatures of 100° C. to 300° C., preferably 120° C. to 250° C. and particularly preferably 140° C. to 230° C. In particular, the hot-crosslinking material may be a reactive material which can be injected, at temperatures below the respective specified crosslinking temperature of the material, into a hot mold. Liquid silicone rubber is usually injected at room-temperature-like temperatures (15° C.-30° C.). In particular, the hot-crosslinking material can exhibit thermal expansion in the mold.

The term “starting substance” refers in principle to any desired substance that forms the basis for a certain material. For the production of the material, the starting substance may be involved in particular in a chemical reaction with other starting substances. The starting substance may in particular be selected from the following group: a polymer, a catalyst, a crosslinking agent. Other starting substances are also conceivable in principle.

The hot-crosslinking material may in particular be selected from the following group: a liquid silicone rubber; a solid silicone rubber; an epoxy resin; a polyurethane; a polyurethane foam; a thermoset, in particular a free-flowing thermoset; a polyester resin, a phenolic resin. With preference, the hot-crosslinking material may be a liquid silicone rubber, in particular a quick-crosslinking liquid silicone rubber. Other materials are also conceivable in principle. In particular, the hot-crosslinking material, in particular the liquid silicone rubber, may have a cycle time of less than 60 s. Other cycle times are also conceivable in principle. The cycle time may depend in particular on a tool temperature and a shape of the finished part. Other parameters are also conceivable. Thin-walled component parts may have for example a cycle time up to 10 s, whereas thick-walled component parts may have a cycle time longer than 60 s. Additional parameters influencing the cycle time may be: a material composition, one or more process parameters such as the tool temperature. Within the context of the present invention, a “cycle time” is understood to mean fundamentally a period of time or duration for producing a finished part from a hot-crosslinking material.

The term “liquid silicone rubber” (LSR) fundamentally denotes any desired material on the basis of two-component silicone elastomers. The injection molding of two-component silicone elastomers fundamentally involves a crosslinking of two polymers within the tool mold. The crosslinking may also be referred to as addition crosslinking. Crosslinking polymers used are for example polydimethylsiloxane (PDMS), which is made to undergo crosslinking using the crosslinking agent H-siloxane and a platinum catalyst. Liquid silicone rubber can be shaped and prepared in principle at high temperatures and with very fast cycle times. The high temperatures of the tool make it possible to greatly speed up the crosslinking reaction, such that finished parts can be produced within a few seconds. Plastics component parts for different sectors, from sealing lips for vehicle headlights through to contact lenses, can be produced from liquid silicone rubber.

Liquid silicone rubber can be prepared in particular with two components, A and B, which are mixed in a 1:1 ratio and undergo three-dimensional crosslinking in a platinum-catalyzed addition reaction. The reaction can be accelerated in particular by preparation temperatures of 150° C. to 230° C. At room temperature, a pot life may require several days. The base polymer may be in particular a polydimethylsiloxane (PDMS), which can be adapted to desired requirements by substituting various functional groups. The crosslinking reaction between the two components proceeds fundamentally exothermically, irreversibly and without disassociation products. It can be described by the Chalk-Harrod mechanism. The A component generally comprises a catalyst, in particular a platinum complex, while the B component comprises a crosslinking agent in the form of H-siloxane. By contrast to the already well-researched thermoplastics, there is fundamentally little knowledge about the process of preparing liquid silicone rubber. Although the curing kinetics of liquid silicone rubber have already been investigated in more detail and studies relating to the simulation of liquid silicone rubber have been carried out, the application of these findings to a real injection molding process is lacking. Liquid silicone rubber fundamentally involves a crosslinking reaction without disassociation products. However, there are other processes and/or reaction mechanisms, such as polycondensation, in which disassociation products are produced during the crosslinking reaction. Finished parts or component parts made of liquid silicone rubber can optionally be subjected to heat treatment in a further process step.

The liquid silicone rubber may be selected from the following group: a self-lubricating liquid silicone rubber; a self-adhesive liquid silicone rubber; an optical liquid silicone rubber; a medical liquid silicone rubber; an insulating liquid silicone rubber. Furthermore, the liquid silicone rubber may be selected from the following group: a highly wear-resistant liquid silicone rubber; a liquid silicone rubber without further curing; a thermally stable liquid silicone rubber; a cold-resistant liquid silicone rubber; a flame-retardant liquid silicone rubber; a low-viscosity liquid silicone rubber. Other types of liquid silicone rubber are also conceivable in principle.

Injection molding processes for thermoplastics and liquid silicone rubbers differ fundamentally on crucial points, such as chemical properties, procedure and process parameters. The injection molding process with liquid silicone rubbers fundamentally involves a chemical crosslinking of various polymers, thus producing the solid form. Thermoplastics, by contrast, fundamentally solidify. The starting substances of the liquid silicone rubber are fundamentally not heated before they are injected into the cavity of the tool and are therefore injected in the cold state, whereas thermoplastics in principle are melted at higher temperatures in order to be flowable. Moreover, cycle times and tool internal pressures arising in an injection molding process for liquid silicone rubber are fundamentally longer than they are with thermoplastics. A crucial difference lies fundamentally in the pressure profiles of the tool internal pressure, which can be very different between liquid silicone rubbers and thermoplastics. This manifests itself primarily in the fact that, in the case of liquid silicone rubbers, the tool internal pressure during the injection molding process increases fundamentally owing to the thermal expansion of the initially cold starting substance in the hot tool, whereas in the case of thermoplastics the tool internal pressure can drop again in the follow-up pressure phase after the injection operation has finished. The pressure profile during the preparation of liquid silicone elastomers is completely different, fundamentally owing to a reverse temperature control (cold starting substances are injected into the hot tool). This fundamentally leads to a thermal expansion of the component part in the tool as a result of the constant input of heat once the starting substances are in the hot tool. As the process time passes, the tool internal pressure therefore continuously increases until the finished part is ejected.

As stated above, in step d) the profile of the tool internal pressure in step c) is recorded. The profile of the tool internal pressure can thus be tracked during the primary forming process itself, in particular during the production of the finished part, in particular in order to track the profile of the chemical crosslinking reaction thereby.

The term “crosslinking reaction” in this case denotes a chemical reaction in which a multiplicity of macromolecules are bonded to afford a three-dimensional network, it being possible for the bond to form in particular on existing macromolecules. The crosslinking reaction takes place with the selection of certain parameters, in particular pressure and temperature, the bonding of the macromolecules generally continuously increasing as the crosslinking reaction progresses. After the crosslinking reaction, there is a change in the chemical, physical and/or mechanical properties of the material, which are also referred to as “material parameters”. A specified measure of the change in the material during the production of the finished part is generally a value for a degree of crosslinking, the “degree of crosslinking” being defined by a proportion of crosslinked sites relative to a total amount of the plastic.

A falling gradient of the tool internal pressure profile is fundamentally a characteristic feature which shows that the crosslinking reaction, in particular between the two polymers of the liquid silicone rubber, has concluded. The crosslinking reaction takes place, in principle, suddenly and is quickly concluded. If, during the measurement of the tool internal pressure, a peak in the tool internal pressure profile is registered, it is possible after a short period of waiting to assume from this that the crosslinking reaction has concluded. In principle, different materials exhibit different pressure and temperature profiles and therefore have different cycle times.

In step e), as stated above, the tool internal pressure profile is differentiated, at least once or at least twice, to determine the first-order and/or second-order derivative. The term “derivative” fundamentally refers to a limit value of the difference quotient of a function. This means that, for each x value of a function, it is examined whether the y value of the previous x value and of the next x value is greater than, smaller than, or the same as the y value of the evaluated x value. A derivative function describes a function that describes the slope behavior of the evaluated function at any point. The function f(x) has the derivative function f(x). The derivative function f(x) is referred to as the first derivative or first-order derivative.

The derivative of the first derivative is the derivative function f″(x). The derivative function f″(x) is referred to as the second derivative or second-order derivative.

As stated above, in step f) the profile of the chemical crosslinking reaction is characterized by means of the first-order and/or second-order derivative. In step f), the characterization of the profile of the chemical crosslinking reaction may be determined in particular by ascertaining at least one of the following specific variables:
a zero crossing of the second-order derivative;
a profile of the second-order derivative;
an extreme value of the second-order derivative.

Furthermore, in step f), the characterization of the profile of the chemical crosslinking reaction may be determined in particular by ascertaining at least one of the following specific variables:
a zero crossing of the first-order derivative;
a profile of the first-order derivative;
an extreme value of the first-order derivative.

In particular, the tool internal pressure profile, in particular the variation over time of the tool internal pressure, has at least one first phase, at least one second phase, and at least one third phase. The second phase may follow the first phase. The third phase may follow the second phase. The first phase, the second phase and the third phase may have different average rises in pressure. The first phase can be referred to as heating phase or temperature-increasing phase. In the first phase, the starting substance for the hot-crosslinking material can be heated and thereby expand. The second phase may be referred to as crosslinking phase. In the second phase, the starting substance for the hot-crosslinking material can undergo crosslinking, in such a way that the hot-crosslinking material is produced. The crosslinking reaction may be an exothermic crosslinking reaction. It may involve an expansion of the hot-crosslinking material. In addition, in the second phase, shrinkage owing to a change in density may occur. In the third phase, the hot-crosslinking material can be heated to a set mold temperature and can thereby expand. The tool internal pressure profile respectively in the first phase, in the second phase and in the third phase can depend in particular on one or more of the following parameters: machine parameters, material, finished-part geometry, tool structure. Further parameters having an influence are also possible.

In particular, in step f), the profile of the chemical crosslinking reaction can be characterized by an examination and/or evaluation of the first-order derivative and/or the second-order derivative during the first phase, in particular the heating phase, and/or during the second phase, in particular the crosslinking phase. The method according to the invention thus makes it possible fundamentally to detect the crosslinking of the hot-crosslinking material in a phase in which a In the first phase and in the second phase there are fundamentally only small deviations in the tool internal pressure profile. By means of the first-order derivative and/or by means of the second-order derivative, these deviations can be, in principle, reliably identified in automated fashion. It is therefore fundamentally not necessary to wait until the finished part, in particular the complete finished part, has assumed a tool temperature and a thermal expansion of the finished part is virtually zero. Then, the tool internal pressure fundamentally no longer rises.

In particular, by means of step f) a conclusion of the chemical crosslinking reaction can be determined. In particular, if step f) is used to determine the conclusion of the chemical crosslinking reaction, step c) can be ended. Furthermore, by virtue of step f), a cycle time of the production of the finished part from liquid silicone rubber in the primary forming process can be optimized.

This type of evaluation can fundamentally allow conclusions to be drawn about material changes during the crosslinking reaction. In this way, the cycle time of the primary forming process can be optimized and analyzed by measuring instrumentation.

To carry out the method according to the invention, it is possible to provide preferably an electronic device, in particular a computer, which comprises program code set up to carry out the present method.

In a further aspect, the present invention relates to a computer program set up to carry out the described steps of the method, in particular steps b) to f), and, if appropriate, further steps. For details in this respect, reference is made to the description of the method according to the invention.

In a further aspect of the present invention, a method for process monitoring during production of a finished part from a hot-crosslinking material in a primary forming process is proposed. The apparatus comprises at least one tool which is set up for carrying out the primary forming process. The tool has at least one cavity for receiving at least one starting substance for the hot-crosslinking material and the tool also has an apparatus for determining a tool internal pressure. The apparatus also has at least one controller. The controller is set up to carry out at least steps b) to f) of the method as were described above or are yet to be described hereinafter.

For further details relating to the apparatus according to the invention, reference is made to the description of the method according to the invention.

### Advantages of the Invention

The present method and the associated apparatus allow continuous monitoring of the quality of a finished part in a series production with the aim of zero-fault production with one hundred percent quality. Making visible the crosslinking of starting substances of the hot-crosslinking material during the injection molding process allows precise component-part and process monitoring. In addition, this makes it possible to determine the cycle time of finished parts exactly and track a profile of the crosslinking reaction. In particular, a crosslinking can be determined and/or read off of a measured tool internal pressure curve.

It is possible to specifically evaluate the tool internal pressure measured to some extent as standard practice for process monitoring. The tool internal pressure curve can be subjected to double derivation and the largest peak within the range to be expected can be determined as the point at which the crosslinking has concluded. This works in principle both in an injection molding tool for series processes and in a smaller measurement setup. It is possible to obtain information about the crosslinking for each component part produced and, if appropriate, document that information, in particular for quality control or traceability.

It is possible to determine the optimum cycle time on the basis of the set tool temperature and a traceability of the crosslinking reaction live during the production. The cycle time can be optimized. This makes it possible to cut back on costs and utilize resources more efficiently. Apart from quality control, the analysis of the tool internal pressure can, however, also be used to set and optimize the cycle times when setting up new production processes.

In the case of the present invention, however, the tool internal pressure profile can be used to track the chemical crosslinking reaction per se. In particular, a search can be carried out for a characteristic segment and/or a characteristic area in the tool internal pressure profile. In particular, a search can be carried out for discontinuities such as inflection points, falling gradients, rising gradients and/or gradient profiles during the heating phase. It is not necessary to wait until the material has completely warmed up and thus expanded.

### BRIEF DESCRIPTION OF THE FIGURES

Preferred exemplary embodiments of the present invention are depicted in the figures and are explained in more detail in the following description without restricting the generality. In the figures:

FIG. 1 shows a schematic depiction of a preferred exemplary embodiment for an apparatus according to the invention for process monitoring during production of a finished part from liquid silicone rubber in a primary forming process;

FIGS. 2A and 2B show a schematic profile of a pressure signal plotted against the temperature in a cavity, subdivided into three phases (FIG. 2A) and a schematic depiction of the second derivative of the pressure signal with a characteristic curve, which marks the crosslinking of the liquid silicone rubber (FIG. 2B);

FIGS. 3A and 3B show a sectional CAD depiction of a testing chamber (FIG. 3A) and a component part used for pressure measurement during the injection molding process (FIG. 3B);

FIG. 4 shows results of DSC measurements for Silopren 2050, in particular a temperature-based depiction of the crosslinking for various heating rates;

FIGS. 5A to 5C show a measurement of pressure and temperature of Silopren 2050 over the measured time during heating from 25° C. to 150° C. with a heating rate of 2.9 K min⁻¹, holding at 150° C. and cooling to 25° C. (FIG. 5A); a pressure of Silopren 2050 plotted against temperature on heating and cooling (FIG. 5B), and a smoothed pressure curve with the first and the second derivative for Silopren 2050 and Silastic MS-1002 (FIG. 5C); and

FIG. 6 shows smoothed pressure curves for Silopren 2050 in the injection molding tool at a tool temperature of 150° C. and 180° C.

### EMBODIMENTS OF THE INVENTION

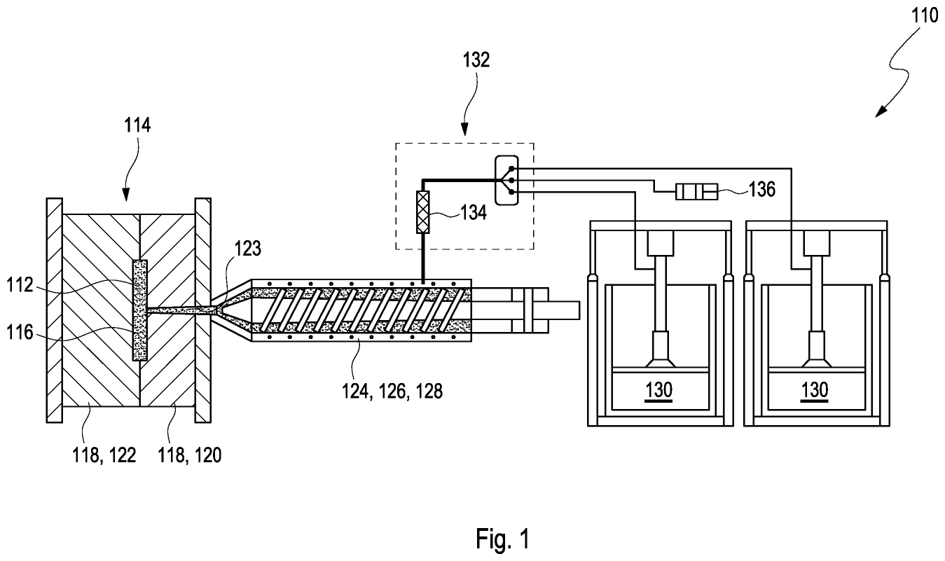

FIG. 1 shows a schematic depiction of a preferred exemplary embodiment for an apparatus 110 according to the invention for process monitoring during production of a finished part 112 from liquid silicone rubber in a primary forming process.

FIG. 1 depicts a tool 114 of the apparatus 110. The tool 114 has a cavity 116, the cavity 116 in FIG. 1 being in the form, by way of example, of a hollow space between two mold plates 118, which have been fitted together and usually are referred to as nozzle-side mold plate 120 and closing-side mold plate 122. The nozzle-side mold plate 120 in this case has an opening 123 into which an injection device 124 enabling the introduction of components 130 of the liquid silicone rubber into the cavity 116 has been introduced. The injection device 124 may have in particular a delivery unit 126, in particular an extruder 128. The tool 114 may have in particular a heating device and an apparatus for determining a tool internal pressure. They are not depicted in FIG. 1.

The components 130 can be mixed in particular by means of a mixing apparatus 132, which can comprise in particular a static mixer 134, of the apparatus 110. Furthermore, the apparatus 110 can have a metering apparatus 136 for inks or additives which is connected to the mixing apparatus 132.

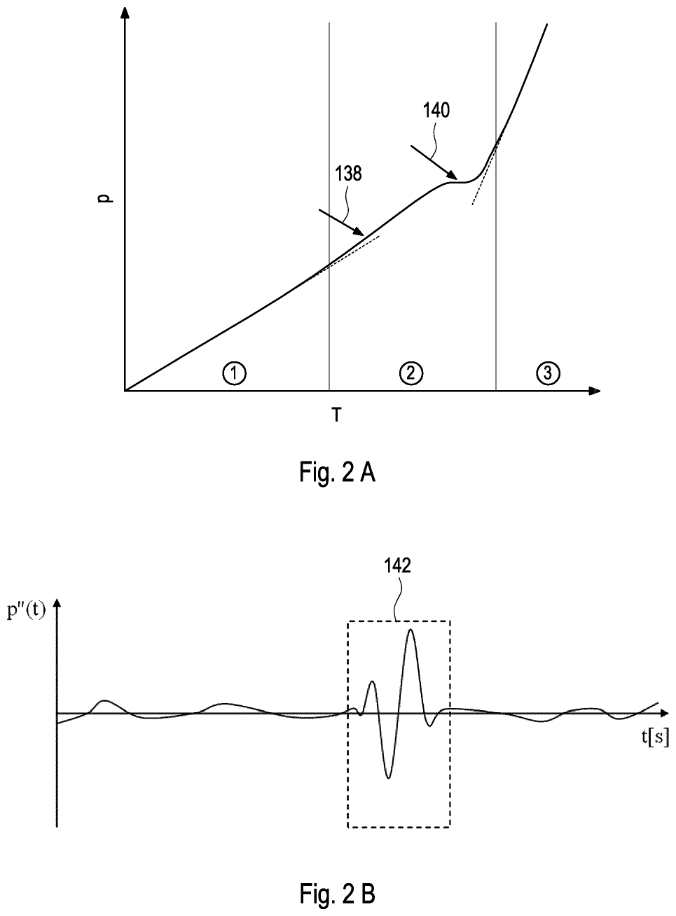

FIG. 2A shows a schematic profile of a pressure signal p plotted against the temperature T in a cavity, subdivided into three phases 1, 2 and 3.

The tool internal pressure curves for component parts made of thermoplastics and those for component parts made of liquid silicone rubber exhibit fundamentally the following critical differences: By contrast to products made of thermoplastics, the shrinkage in the case of injection molding is superposed by the thermal expansion of the liquid silicone rubber in the hot tool. Therefore, the tool internal pressure curves look fundamentally different than in the case of the preparation of thermoplastics. Heating the cold liquid silicone rubber compound to tool temperatures of up to 220° C. causes the pressure in the tool to fundamentally continuously rise. Depending on a geometry of the tool, a position of the pressure sensor and a thickness of the component part, various phases can be identified in the pressure profile. These phases can in principle be described by the following three material stages, which are depicted schematically in FIG. 2A:
Phase 1: Liquid material is heated and thereby expands.
Phase 2: Crosslinking phase: The material shrinks owing to the change in density, while additional heat is supplied by the exothermic crosslinking reaction. The heating is continued and the liquid silicone rubber expands. An overlapping of the effects can be observed. At the location marked with arrow 138, it can be seen that additional exothermic crosslinking energy leads to more expansion.
Phase 3: The solid material is heated to the set mold temperature and thereby expands. At the location marked with arrow 140, it can be seen that a drop in density during the curing leads to a stagnant pressure.

FIG. 2B shows a schematic depiction of the second derivative p″(t) of the pressure signal with a characteristic curve, which marks the crosslinking of the liquid silicone rubber.

According to the theory described above, the crosslinking within phase 2 of the pressure curve is visible during the injection molding process. A double derivation of the measured tool internal pressure profile makes it possible to determine a characteristic point through zero in the second derivative, accompanied by larger deflections both upward and downward, as shown in FIG. 2B: see box 142. About this point, the tool internal pressure curve initially exhibits a greatly increased slope, and then the slope decreases abruptly and shortly thereafter returns to a continuous slope.

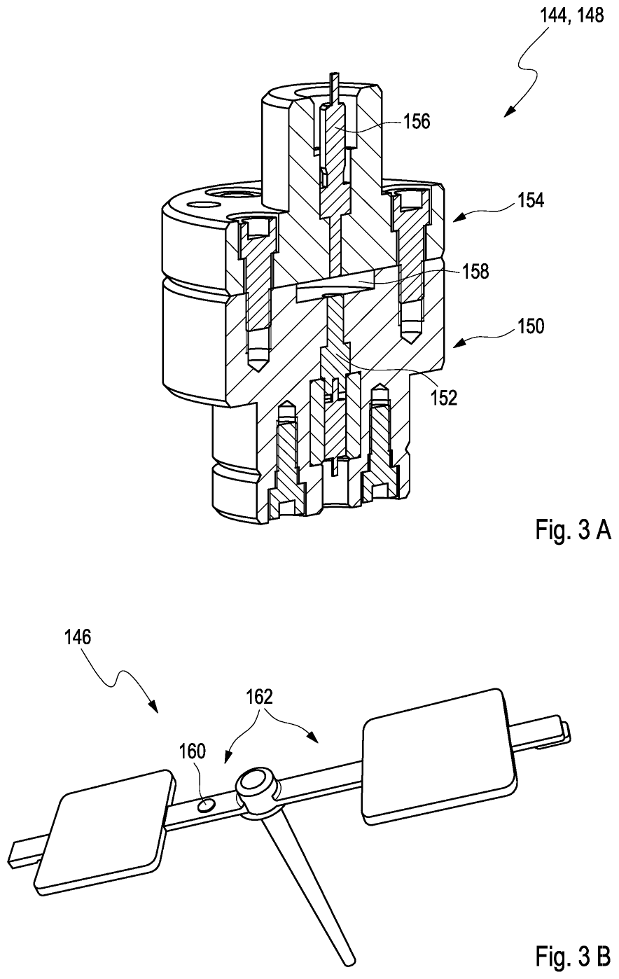

The following FIGS. 3A to 6 relate to experiments that have been conducted. A commercial two-component liquid silicone rubber material from Momentive (Silopren™ LSR 2050) with a Shore A hardness of 50 was used. Components A and B were mixed in a 1:1 ratio. In order to prove the general validity of the results, an optical liquid silicone rubber formulation Silastic™ Ms-1002, with a Shore A hardness of 72, from Dow was also investigated. The two components were also mixed in a 1:1 ratio.

Differential scanning calorimetry (DSC) is prior art for determining the crosslinking reaction of reactive materials such as liquid silicone rubber. DSC measurements are used as reference methods hereinafter. The DSC measurements were taken with a differential scanning calorimeter/differential thermal analyzer DSC 214 Polyma from NETZSCH Gerätebau GmbH. Specimen masses of 10 mg were investigated at four heating rates (1 K min⁻¹, 2.9 K min⁻¹, 5 K min⁻¹ and 10 K min⁻¹) in once-pierced and welded aluminum crucibles.

For dynamic measurements, use was made of the specimen crucible and an empty, once-pierced aluminum crucible as reference. The temperature profile comprises an initial heating from −70° C. to 220° C., a cooling and subsequent holding time of 15 minutes at −70° C., and a second heating to 220° C. The second heating in principle ensures that the liquid silicone rubber has already completely undergone crosslinking after the first heating. During the measurement, purging with nitrogen was performed. Each series of measurements was carried out at least twice. The specimen material investigated was taken directly from the injection molding plasticizing unit. In the preparation of the specimen, for all the measurements, a period of time of 20 minutes was observed between removing the material and starting the measurement. For the evaluation of the DSC measurements, only the two heating curves were used. The first heating curve shows the crosslinking reaction by way of an exothermic peak, while the second heating curve at this point in time remains unchanged, since the material has already completely and irreversibly undergone crosslinking.

FIG. 3A shows a sectional CAD depiction of a testing chamber 144 and FIG. 3B shows a component part 146 used for pressure measurement during the injection molding process.

To ascertain the pressure characteristics of liquid silicone rubber with a constant change in volume and temperature, a testing apparatus 148 was developed. As shown in FIG. 3A, the testing apparatus 148 comprises a lower part 150 with a central injection molding pressure sensor 152, model 6157C from Kistler, and an upper part 154 with a central temperature sensor 156, model 6193A from Kistler. The testing apparatus 148 also comprises a specimen space 158. The specimen space 158 has a diameter of 19.89 mm, a height of 3.01 mm and thus a volume of 935.25 mm³. For the measurements, 1.04 g of liquid silicone rubber was introduced into the lower part of the specimen space 158, the upper part was placed on and secured by four screws with a torque of 10 Nm in each case.

Preliminary investigations have shown that this is the optimum tightening torque. If the tightening torque is too low, the testing chamber 144 in principle opens during the thermal expansion of the liquid silicone rubber and the pressure abruptly drops. If the tightening torque is too high, the liquid silicone rubber is subjected to preloading and the pressure in the testing chamber 144 is high already at the start of the measurement.

The testing apparatus 148 was placed in a climate-controlled chamber (espec SH-241) temperature-controlled to 25° C. (not depicted in FIG. 3A). Sensor cables were laid in a special cable duct. Moreover, a temperature sensor of type K for recording a chamber temperature was installed in the climate-controlled chamber. The two temperature sensors and the pressure sensor were connected to the process monitoring unit, a ComoNeo model 5887A from Kistler. The measurement data in the climate-controlled chamber and in the testing apparatus 148 were continuously recorded, while the climate-controlled chamber was heated with a heating rate of 2.9 K min⁻¹ from 25° C. to 150° C., held at this temperature for an hour, and them cooled back down to 25° C.

In order to prove the validity of the investigated effect in a real injection molding process, liquid silicone rubber component parts with different setting parameters were produced. To this end, the component part 146 shown in FIG. 3B was produced from the same material,

Silopren LSR 2050. A tool internal pressure sensor 160, 6152B from Kistler, is in the region of a sprue 162. The sprue 162 has a thickness of 2.5 mm at this location. Pressure signals were evaluated with a process monitoring unit, ComoNeo model 5887A.

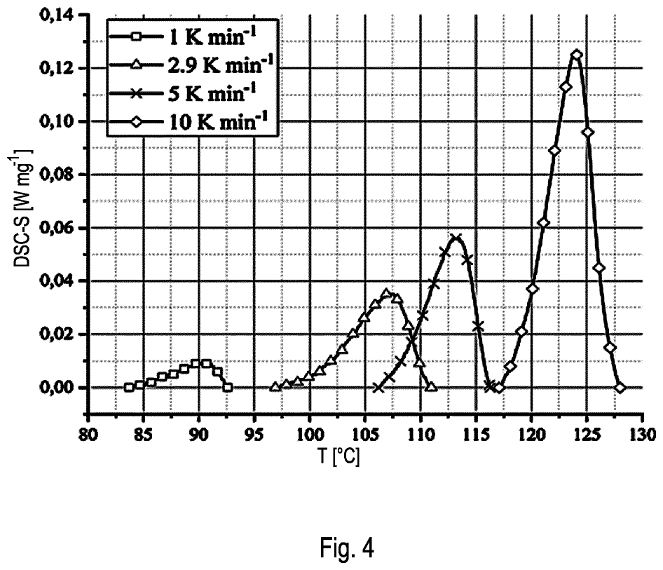

FIG. 4 shows results of DSC measurements for Silopren 2050, in particular a temperature-based depiction of the crosslinking for various heating rates. It depicts the DSC signal DSC-S in W mg⁻¹ as a function of the temperature T in ° C. Different heating rates were used. The curve marked with squares exhibits a profile at a heating rate of 1 K min⁻¹. The curve marked with triangles exhibits a profile at a heating rate of 2.9 K min⁻¹. The curve marked with crosses exhibits a profile at a heating rate of 1 K min⁻¹. The curve marked with rhombi exhibits a profile at a heating rate of 1 K min⁻¹.

In the case of the DSC measurements carried out, it is possible in principle to depict the crosslinking reaction at various heating rates, as FIG. 4 shows. For instance, at a heating rate of 2.9 K min⁻¹ (curve with triangles), an exothermic crosslinking reaction starts at 97° C., attains a conversion maximum at 107° C. and has concluded at 112° C. The new measurement method should exhibit the same result over the pressure curve at a constant heating rate.

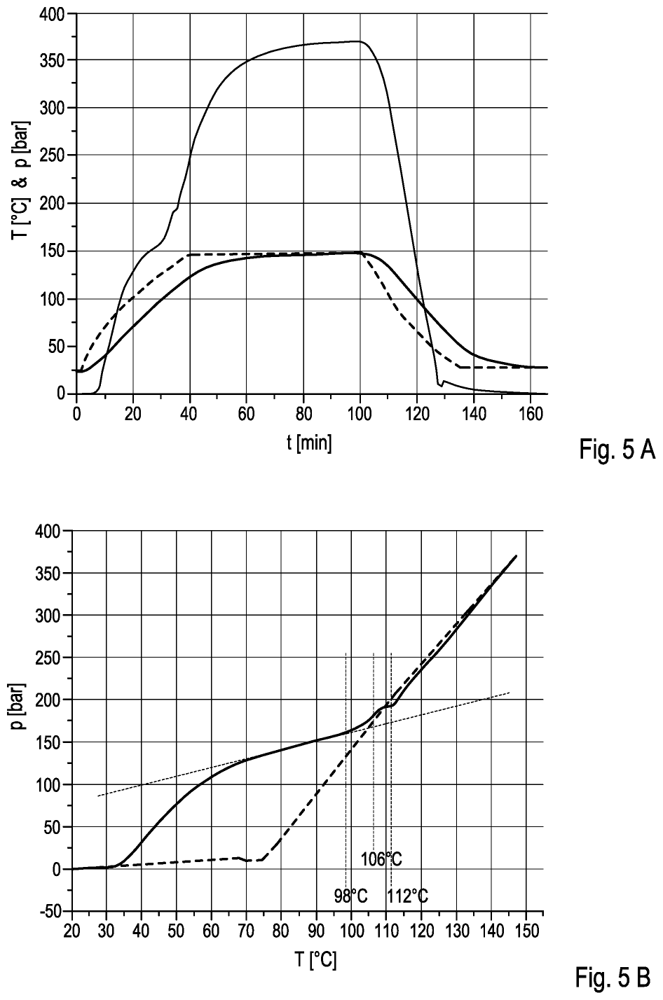

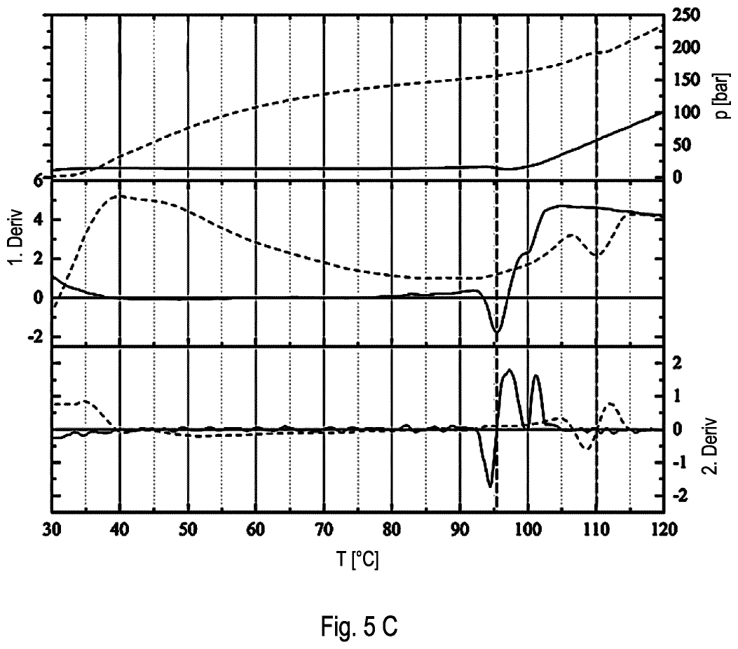

FIG. 5A shows a measurement of the pressure and temperature of Silopren 2050 over the measured time during heating from 25° C. to 150° C. with a heating rate of 2.9 K min⁻¹, holding at 150° C. and cooling to 25° C. The temperature T in the climate-controlled chamber (dashed line), the temperature T in the testing chamber 144 (solid line) and the pressure p in the testing chamber 144 are each depicted as a function of the measured time t.

First of all, the oven is heated to 150° C. at 2.9 K min⁻¹. This temperature is maintained for one hour, in order for the oven temperature to reach the specimen chamber. During this time, the pressure in the specimen space rises to up to 370 bar. The oven is then cooled to 25° C. The pressure drops rapidly to 0 bar owing to the above-described shrinkage.

FIG. 5B shows a pressure p of Silopren 2050 plotted against the temperature T during heating and cooling. Indicated are the distinctive points of the DSC measurement at the start of crosslinking (98° C.), on maximum conversion (106° C.), and at the end of crosslinking (112° C.).

FIG. 5B shows the series of measurements depicted in FIG. 5A as a plot of the pressure profile against the chamber temperature. The different profiles of the heating and cooling curves are clearly visible. While at the start of the heating operation, effects fundamentally of no interest that are linked to the filling of the testing apparatus 148 occur, from 70° C. a continuous rise in pressure is achieved. In FIG. 5B, the distinctive points on the heating curve have been marked by extending the linear regions. As FIG. 5B shows, the pressure profile starts to increase at 98° C. and reaches its maximum at 106° C. From 112° C., the pressure curve increases again to form a continuous curve, which increases linearly, up to a pressure of 370 bar, to the maximum temperature. The distinctive points correspond to the temperatures to be expected that were ascertained during the DSC measurement. They are the crosslinking start and end points and the peak temperature, at which the crosslinking exhibits maximum conversion. On cooling, the measured pressure drops until it reaches zero at 75° C. This can be explained by the crosslinking shrinkage, as a result of which the liquid silicone rubber specimen no longer comes into contact with the injection molding pressure sensor 152. The measurements showed that the specimen that underwent crosslinking has a thickness of 2.92 mm at room temperature. Taking the testing chamber height of 3.01 mm into account, this corresponds to a shrinkage of 3.0%.

FIG. 5C shows a smoothed pressure curve (top) with first derivative (center) and second derivative (bottom) for Silopren 2050 (respective dashed line) and Silastic MS-1002 (respective solid line). The second derivative exhibits a characteristic profile at 110.1° C. and at 95.3° C.

Since the crosslinking is fundamentally of special interest from a procedural perspective, the heating curve is considered in more detail below. In order to make the crosslinking region clear, in FIG. 5C the pressure profile is subjected to double derivation with respect to the temperature for Silopren 2050 (respective dashed line) and, as validation, another type of liquid silicone rubber, Silastic MS-1002 (respective solid line). What is evident in the case of Silopren only as a discontinuity of the gradient in the pressure curve at approximately 110° C. can be seen clearly in the case of the second derivative. The curve profile is typical here: large downward change in the gradient, zero point, and large upward change in the gradient. This curve profile fundamentally reflects the material changes during the crosslinking.

The evaluation of the derivative of Silopren 2050 shows a zero point of the second derivative at 110.1° C. Compared with the characteristic temperatures of the DSC measurement, it is evident that, for Silopren 2050, there is a correlation between the end of the crosslinking in the DSC measurement at 112° C. and the zero point of the second derivative of the pressure curve at 110.1° C. The further liquid silicone rubber material, an optical liquid silicone rubber formulation (Silastic MS-1002 from Dow), is also investigated. The DSC measurement shows the maximum conversion (peak) at a temperature of 95.3° C. On measuring the low-viscosity material in the testing chamber, a characteristic profile for the crosslinking at 95.4° C. was found with the double derivation method. By contrast to Siloprene 2050, here the zero point coincides with the crosslinking rate maximum (peak) in the DSC measurement.

The curve before the occurrence of the crosslinking peak is very different in the two investigated materials. It is assumed that this can be attributed to the different viscosities and the associated filling of the measuring instrument. While the very low-viscosity Silastic MS-1002 can be poured into the measuring instrument like water, and owing to gravitational force flows out flat and completely fills the measuring instrument, the very high-viscosity Silopren 2050 by contrast cannot be poured in as easily. On being poured in, the material is disposed in the center and then pressed flat when the lid is put on. However, the mass is also then relatively dimensionally stable and does not immediately completely fill the measuring instrument. The free regions at the edge are only filled by a combination of a rise in temperature and associated decrease in viscosity, and thermal expansion and associated displacement toward the edge, and this becomes noticeable in the signal of the pressure sensor. In addition, the thermal expansion depends on the material composition. For instance, a high filler content leads to relatively little shrinkage, since the thermal expansion of the filler is less than that of the polymer matrix. Optical silicones for example have a high filler content, and this in turn, as can be seen in FIG. 5C, leads to a lower thermal expansion and thus a lower pressure in the cavity.

Accordingly, it can thus in principle be shown that the evaluation methods of double derivation of the pressure signal can be used irrespective of the material to depict the crosslinking in the pressure signal. It can also be shown that the zero point in the second derivative, depending on the liquid silicone rubber composition, coincides both with the end of the crosslinking process and with the maximum crosslinking conversion.

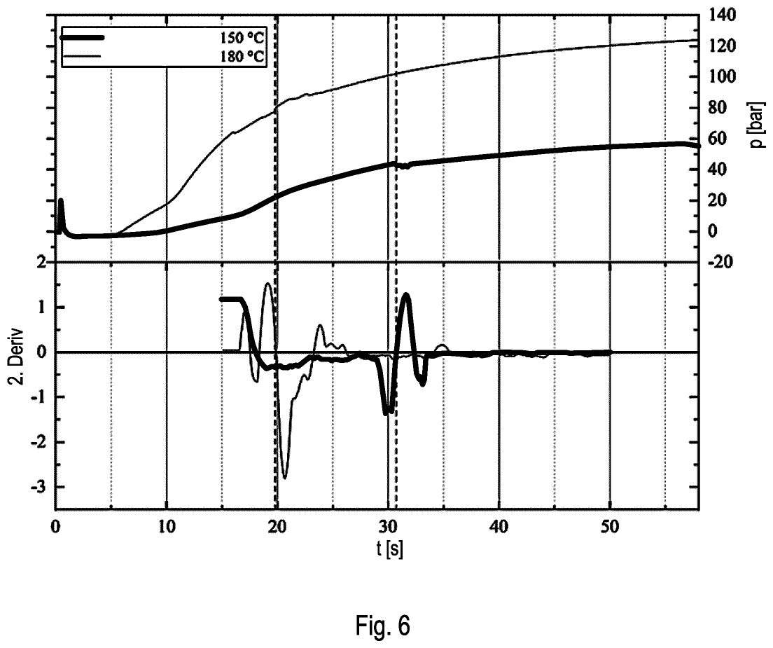

FIG. 6 shows smoothed pressure curves for Silopren 2050 in the injection molding tool at a tool temperature of 150° C. (solid line) and 180° C. For the creation of both pressure curves, a respective injection velocity of 50 cm s⁻¹ was used.

In order to make the interpretation of the pressure signal usable for the liquid silicone rubber preparation industry, the measurement methodology with its characteristic curve was transferred to the tool internal pressure of injection molding tools. To this end, the tool internal pressure during the production of liquid silicone rubber component parts was measured. Since in this case, too, it is a closed system like the testing chamber, the crosslinking reaction was also able to be measured in the pressure profile.

Many tools in industrial practice are not equipped with temperature sensors. For this reason, in principle variations in pressure over the cycle time are available. An evaluation of the second derivative shows two different characteristic curves for the two tool temperatures: At a tool temperature of 150° C., the zero point of the second derivative is found after 30.8 s, whereas at a tool temperature of 180° C. there is a zero point after 19.8 s. To validate the results, the crosslinking profiles and conversions for both tool temperatures were simulated with a well-fitting simulation method. As regards the well-fitting simulation method, reference is made to the publication by D. F. Weißer, D. Walz, J. Schmid, D. Mayer, M. H. Deckert, Jnl Adv Manuf & Process 2020. Accordingly, complete crosslinking occurs after 31.2 s at a tool temperature of 150° C. and after 19.0 s at a tool temperature of 180° C. Therefore, the end of crosslinking, measured in the pressure curve, at a tool temperature of 150° C. deviates by 0.4 s (1.3%) and the crosslinking time at a tool temperature of 180° C. deviates by −0.8 s (−4.0%) with respect to the simulation. In the simulation, the injection time of 0.6 s through to complete filling of the tool is taken into account.

It is evident from the test data that the evaluation of the pressure profiles during the injection molding process alludes to the crosslinking process. Moreover, the ascertained temperatures for the concluded crosslinking match the simulation values except for small measurement uncertainties. The measured values for the pressure profile match the simulation values to a high degree, in spite of smoothing.

### LIST OF REFERENCE SIGNS

110 Apparatus
112 Finished part
114 Tool
116 Cavity
118 Mold plate
120 Nozzle-side mold plate
122 Closing-side mold plate
123 Opening
124 Injection device
126 Delivery unit
128 Extruder
130 Component
132 Mixing apparatus
134 Static mixer
136 Metering apparatus
138 Arrow
140 Arrow
142 Box
144 Testing chamber
146 Component part
148 Testing apparatus
150 Lower part
152 Injection molding pressure sensor
154 Upper part
156 Temperature sensor
158 Specimen space
160 Tool internal pressure sensor
162 Sprue

1. A method for process monitoring during production of a finished part from a hot-crosslinking material in a primary forming process, the method comprising the following steps:
a) providing at least one tool which is set up for the primary forming process, the tool-having at least one cavity for receiving at least one starting substance for the hot-crosslinking material, and further an apparatus for determining a tool internal pressure being integrated in the tool;
b) heating the tool;
c) introducing the at least one starting substance for the hot-crosslinking material under pressure into the cavity, such that the finished part is produced;
d) recording a variation in the tool internal pressure over time that develops in step c);
e) differentiating, at least once or at least twice, the tool internal pressure profile to determine at least one derivative selected from the following group: the first order derivative; the second order derivative; and
f) characterizing a profile of a chemical crosslinking reaction by means of at least one derivative selected from the following group: the first-order derivative; the second-order derivative.

2. The method as claimed in claim 1, wherein the hot-crosslinking material is selected from the following group: a liquid silicone rubber; solid silicone rubber; an epoxy resin; a polyurethane; a polyurethane foam; a thermoset, in particular a free-flowing thermoset.

3. The method as claimed in claim 1, wherein the hot-crosslinking material is liquid silicone rubber.

4. The method as claimed in claim 3, wherein the liquid silicone rubber is selected from the following group: a self-lubricating liquid silicone rubber; a self-adhesive liquid silicone rubber; an optical liquid silicone rubber; a medical liquid silicone rubber; an insulating liquid silicone rubber.

5. The method as claim 1, wherein the hot-crosslinking material has a cycle time of less than 60 s.

6. The method as claimed in claim 1, wherein, in step f), the profile of the chemical crosslinking reaction is characterized by an evaluation of the at least one derivative selected from the following group: the first-order derivative, the second-order derivative, during at least one phase of the tool internal pressure profile selected from the following group: a heating phase, a crosslinking phase.

7. The method as claimed in claim 1, wherein the apparatus for determining the tool internal pressure is used to directly and/or indirectly determine the tool internal pressure.

8. (canceled)

9. The method as claimed in claim 1, wherein, in step f), the characterization of the profile of the chemical crosslinking reaction is determined by ascertaining at least one of the following specific variables:
zero crossing of the second-order derivative;
a profile of the second-order derivative;
an extreme value of the second-order derivative.

10. The method as claimed in claim 1, wherein step f) is used to determine a conclusion of the chemical crosslinking reaction.

11. The method as claimed in claim 10, wherein, if step f) is used to determine the conclusion of the chemical crosslinking reaction, step c) is ended.

12. The method as claimed in claim 1, wherein, by virtue of step f), a cycle time of the production of the finished part in the primary forming process is optimized.

13. (canceled)

14. An apparatus for process monitoring during production of a finished part from a hot-crosslinking material in a primary forming process, wherein the apparatus comprises at least one tool which is set up for implementing the primary forming process, the tool having at least one cavity for receiving at least one starting substance for the hot-crosslinking material, and the tool further having an apparatus for determining a tool internal pressure, the apparatus also having at least one controller, the controller being set up to carry out steps b) to f) as claimed in method claim 1.
